(19) United States
(12) Patent Application Publication
(10) Pub. No.: US 2024/0278668 A1
(43) Pub. Date: Aug. 22, 2024

(54) VEHICLE MANAGEMENT DEVICE

(71) Applicant: TOYOTA JIDOSHA KABUSHIKI KAISHA, Toyota-shi (JP)

(72) Inventors: Hideo SAKAMOTO, Toyota-shi (JP); Yoshinobu NOZAKI, Ano-shi (JP); Hiroyuki OGURA, Ama-shi (JP); Mitsuaki TOMITA, Toyota-shi (JP); Yasunobu SEKI, Nisshin-shi (JP); Shoichi IWAMOTO, Fuji-shi (JP); Hisashi FUJISAWA, Toyota-shi (JP)

(73) Assignee: TOYOTA JIDOSHA KABUSHIKI KAISHA, Toyota-shi (JP)

(21) Appl. No.: 18/393,955

(22) Filed: Dec. 22, 2023

(30) Foreign Application Priority Data
Feb. 21, 2023 (JP) 2023-024923

(51) Int. Cl. B60L 53/51; B60L 50/53; H02J 7/35

(52) U.S. Cl. CPC B60L 53/51; B60L 50/53; H02J 7/35

(57) ABSTRACT

The present disclosure provides a vehicle management device used for a vehicle that includes a drive unit for traveling, a power storage device that is able to supply power to the drive unit, and a solar cell system that is able to generate power from a solar cell and supply the power to the power storage device, and that is able to perform external charging in which the power storage device is charged with power from an outside of the vehicle. When the vehicle is parked, a target external charging amount of the external charging is set to a value obtained by subtracting, from a target power storage amount of the power storage device at a next scheduled traveling start time, a predicted power generation amount of the solar cell up to the next scheduled traveling start time.

### CROSS-REFERENCE TO RELATED APPLICATION

This application claims priority to Japanese Patent Application No. 2023-024923 filed on Feb. 21, 2023, incorporated herein by reference in its entirety.

### BACKGROUND

### 1. Technical Field

The present disclosure relates to a vehicle management device.

### 2. Description of Related Art

Conventionally, as a vehicle management device used for a vehicle that charges a battery with power generated by a solar cell, a technique has been proposed in which a power generation amount generated by a solar cell when the vehicle is parked next is estimated based on a past parking status, a power generation amount during parking, and a next parking status, and charging of the battery while the vehicle is traveling is controlled based on the estimated power generation amount (for example, see Japanese Unexamined Patent Application Publication No. 2010-195065 (JP 2010-195065 A)).

### SUMMARY

In a vehicle capable of performing external charging in which a power storage device is charged with power from outside the vehicle, power generation may be performed by a solar cell from when the vehicle is parked and is externally charged until the vehicle starts traveling next time. Once the power storage device is fully charged by the external charging, the power storage device cannot be charged with the power generated by the solar cell thereafter, so that the power generated by the solar cell is wasted.

A main object of the vehicle management device according to the present disclosure is to suppress the power generated by the solar cell from being wasted.

The vehicle management device according to the present disclosure employs the following means to achieve the above-mentioned main object.

The gist of a vehicle management device according to the present disclosure is a vehicle management device used for a vehicle that includes a drive unit for traveling, a power storage device that is able to supply power to the drive unit, and a solar cell system that is able to generate power from a solar cell and supply the power to the power storage device, and that is able to perform external charging in which the power storage device is charged with power from an outside of the vehicle.

When the vehicle is parked, a target external charging amount of the external charging is set to a value obtained by subtracting, from a target power storage amount of the power storage device at a next scheduled traveling start time, a predicted power generation amount of the solar cell up to the next scheduled traveling start time.

In the vehicle management device according to the present disclosure, when the vehicle is parked, a target external charging amount of the external charging is set to a value obtained by subtracting, from a target power storage amount of the power storage device at a next scheduled traveling start time, a predicted power generation amount of the solar cell up to the next scheduled traveling start time. As a result, it is possible to suppress the power generated by the solar cells from being wasted.

In such a vehicle management device according to the present disclosure, when a power storage amount of the power storage device has not reached the target power storage amount by a predetermined time before the next scheduled traveling start time, the external charging may be performed such that the power storage amount of the power storage device reaches the target power storage amount by the next scheduled traveling start time. In this way, it is possible to set the power storage amount of the power storage device to the target power storage amount by the next scheduled traveling start time.

Further, in the vehicle management device according to the present disclosure, when the vehicle is parked at a predetermined spot where the vehicle is assumed to be parked for a predetermined time or more, the target external charging amount may be set to a value obtained by subtracting the predicted power generation amount from the target power storage amount. When the vehicle is parked for less than a predetermined time, it is considered that the power generated by the solar cell during parking is not very large. Therefore, when the vehicle is parked at a predetermined spot where the vehicle is assumed to be parked for a predetermined time or more, by setting the target external charging amount to a value obtained by subtracting the predicted power generation amount from the target power storage amount, the target external charging amount can be set more appropriately.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram schematically showing the structure of a vehicle equipped with a vehicle management device as an embodiment of the present disclosure;

FIG. 2 is a flowchart showing an example of a first processing routine executed by the electronic control unit; and

FIG. 3 is a flowchart showing an example of a second processing routine executed by the electronic control unit before the vehicle starts traveling.

### DETAILED DESCRIPTION OF EMBODIMENTS

Next, modes for carrying out the disclosure will be described using an embodiment.

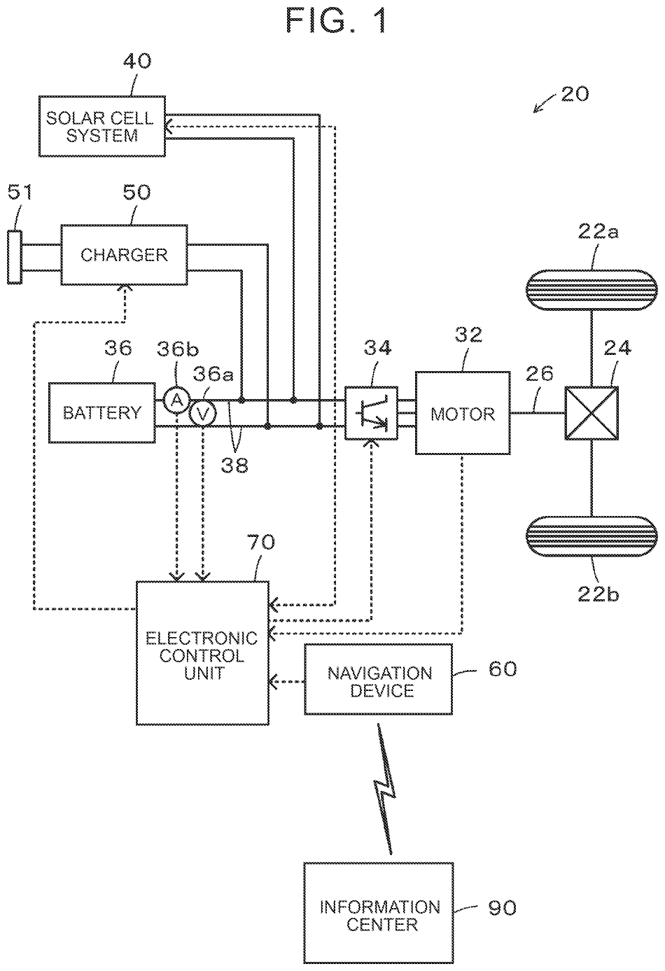

FIG. 1 is a block diagram schematically showing the structure of a vehicle 20 equipped with a vehicle management device according to an embodiment of the present disclosure. As illustrated in the drawing, the vehicle 20 includes a motor 32, an inverter 34, a battery 36 as a power storage device, a solar cell system 40, a charger 50, a navigation device 60, and an electronic control unit 70.

The motor 32 has a rotor connected to a drive shaft 26 that is connected to the drive wheels 22a, 22b via a differential gear 24. The inverter 34 is used to drive the motor 32 and is connected to the battery 36 via a power line 38. The motor 32 is rotationally driven through switching control of a plurality of switching elements (not shown) of the inverter 34 by the electronic control unit 70. The battery 36 is configured as, for example, a lithium ion secondary battery or a nickel metal hydride secondary battery.

The solar cell system 40 is connected to the power line 38 and includes a solar cell and a converter (not shown). A solar cell has a plurality of solar cells, and is fixed to the top surface of the roof portion of the vehicle body, the top surface of the hood, or the like. The converter supplies the power generated by the solar cell to the battery 36 with voltage conversion.

The charger 50 is connected to the power line 38, and receives power from the external power source when the external power source side connector connected to an external power source outside the vehicle such as a household power source is connected to the vehicle side connector 51 such that it can be supplied to the battery 36. Charger 50 is controlled by electronic control unit 70.

When the destination is set, the navigation device 60 sets a travel route from the current location to the destination based on the map information and the current location of the vehicle 20 detected by GPS and the destination, and displays the route on the display, and provides route guidance. The navigation device 60 communicates with an electronic control unit 70. The navigation device 60 communicates with an information center 90 outside the vehicle 20, and transmits the current location of the vehicle 20 to the information center 90, as well as receives information on sunlight (weather, sunrise, sunset, time, etc.) at the current location of the vehicle 20 from the information center 90.

The electronic control unit 70 includes a microcomputer, and the microcomputer includes a CPU, ROM, RAM, flash memory, input/output ports, and communication ports. The electronic control unit 70 receives signals from various sensors through input ports. The signals inputted to the electronic control unit 70 include, for example, the voltage Vb of the battery 36 detected by the voltage sensor 36a, the current Ib detected by the current sensor 36b, the voltage Vs1 and current Is1 on the solar cell side of the converter, and the voltage Vs2 and current Is2 on the battery side of the converter. The electronic control unit 70 outputs various control signals through output ports. Examples of the signals output by the electronic control unit 70 include a control signal to the motor 32, a control signal to the converter of the solar cell system 40, a control signal to the charger 50, and the like. The electronic control unit 70 calculates the power storage ratio SOC of the battery 36 based on the integrated value of the current Ib of the battery 36, and calculates the generated power Ps of the solar cell based on the voltage Vs1 and current Is1 on the solar cell side of the converter. I'm doing calculations. The power storage ratio SOC is the ratio of the amount of power that can be discharged from the battery 36 to the total capacity of the battery 36. The calculation of the power storage ratio SOC and the generated power Ps is performed both when the vehicle 20 is traveling and when the vehicle 20 is parked. The electronic control unit 70 communicates with the navigation device 60, as described above.

In the vehicle 20 configured in this manner, the electronic control unit 70 sets the required torque Td* to the torque command Tm*, and controls the switching of the plurality of switching elements of the inverter 34 so that the motor 32 is driven by the torque command Tm*.

Further, in the vehicle 20, when the vehicle side connector 51 and the external power source side connector are connected while the vehicle is parked, the electronic control unit 70 causes the battery 36 to be charged using power from the external power source (outside the vehicle). External charging is executed by controlling the charger 50.

Then, in the vehicle 20, the next scheduled traveling start time tst is set by input from the user when the vehicle is parked. As the next scheduled traveling start time tst, instead of the input from the user, the average travel start time calculated by the electronic control unit 70 from the history of the parking point and the time when traveling from the parking point is started may be used.

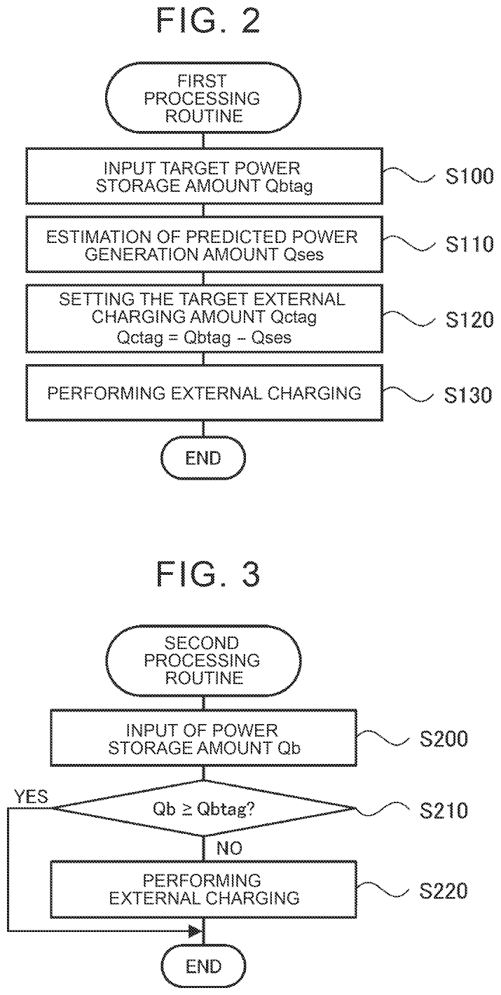

Next, the operation of the vehicle 20 according to the embodiment will be described, particularly the operation when the vehicle side connector 51 and the external power supply side connector are connected while the vehicle is parked and external charging is permitted. FIG. 2 is a flowchart showing an example of the first processing routine executed by the electronic control unit 70. The first processing routine is executed when the vehicle side connector 51 and the external power supply side connector are connected while the vehicle is parked and external charging is permitted.

When the first processing routine is executed, a process of inputting a target power storage amount Qbtag of the battery 36 is executed (S100). As the target power storage amount Qbtag, a value obtained by converting the target power storage ratio SOCbtag into electric energy (a value obtained by multiplying the total capacity of the battery 36 by the target power storage ratio SOCbtag) is used.

Next, the predicted power generation amount Qses of the solar cell system 40 (solar cells) from when the vehicle side connector 51 and the external power source side connector are connected and external charging is permitted until the next scheduled traveling start time tst is estimated (S110). The process of $110 includes, for example, estimating the predicted amount of sunlight Qss during a predetermined period from the current time at the current location of the vehicle 20 to the next scheduled traveling start time tst based on sunlight information (weather, sunrise and sunset times, etc.) from the information center 90. Based on the estimated predicted amount of sunlight Qss, the process of S110 can be performed by estimating the predicted power generation amount Qses of the solar cell system 40 (solar cells) for a predetermined period at the current location of the vehicle 20.

Then, the value obtained by subtracting the predicted power generation amount Qses from the target power storage amount Qbtag is set as the target external charging amount Qctag (S120). When the target external charging amount Qctag is set in this way, the external charging is executed until the amount of power supplied from the external power source becomes the target external charging amount Qctag (S130), and the first processing routine ends. Thereby, it is possible to externally charge the power storage amount Qb of the battery 36 that is insufficient to be generated by the solar cells of the solar cell system 40 by the next scheduled traveling start time tst with respect to the target power storage amount Qbtag. Therefore, it is possible to prevent the power generated by the solar cells from being wasted.

Even if the first processing routine illustrated in FIG. 2 is executed, if the power actually generated by the solar cells becomes lower than the predicted power generation amount Qses due to sunlight conditions, etc., the power storage amount Qb of the battery 36 may not reach the target power storage amount Qbtag until the next scheduled traveling start time tst. Next, a description will be given of an operation performed before starting running in order to more reliably bring the power storage amount Qb of the battery 36 to the target power storage amount Qbtag by the next scheduled running start time tst.

FIG. 3 is a flowchart showing an example of a second processing routine executed by the electronic control unit 70 before the vehicle starts traveling. The second processing routine is performed when the vehicle side connector 51 and the external power supply side connector are connected to each other while the vehicle is parked, and external charging is permitted, and when the next traveling start time tst is scheduled for a predetermined time tref (for example, 30 minutes, 1 hour, 1 hour 30 minutes, etc.).

When the second processing routine is executed, a process for inputting the current power storage amount Qb of the battery 36 is executed (S200). The power storage amount Qb is a value obtained by converting the power storage ratio SOC calculated based on the integrated value of the current Ib of the battery 36 into the amount of electrical storage.

After inputting the power storage amount Qb in this manner, it is determined whether the inputted power storage amount Qb is equal to or greater than the target power storage amount Qbtag (S210). When the power storage amount Qb is equal to or greater than the target power storage amount Qbtag, the second processing routine is terminated, and when the power storage amount Qb is less than the target power storage amount Qbtag, external charging is performed until the power storage amount Qb of the battery 36 reaches the target power storage amount Qbtag (S220), and the second processing routine ends.

Through such processing, even if the first processing routine is executed, if the power storage amount Qb does not reach the target power storage amount Qbtag by a predetermined time tref before the scheduled traveling start time tst, by the next scheduled traveling start time tst using the second processing routine, the power storage amount Qb of the battery 36 can be more reliably set to the target power storage amount Qbtag.

In the vehicle 20 equipped with the vehicle management device of the embodiment described above, it is possible to suppress the power generated by the solar cell from being wasted by setting the target external charging amount Qctag of external charging to the value obtained by subtracting the predicted power generation amount Qses of the solar cell up to the scheduled traveling start time tst from the target power storage amount Qbtag of the battery 36 at the next scheduled traveling start time tst, when the vehicle 20 is parked.

In addition, if the power storage amount Qb of the battery 36 has not reached the target power storage amount Qbtag by a predetermined time tref before the next scheduled traveling start time tst, the external charging is performed such that the power storage amount Qb of the battery 36 will reach the target power storage amount Qbtag by the next scheduled traveling start time tst, so that the power storage amount Qb of the battery 36 can more reliably reach the target power storage amount Qbtag by the next scheduled traveling start time tst.

Although the vehicle 20 equipped with the vehicle management device of the embodiment executes the first processing routine and the second processing routine, it is not necessary to execute the second processing routine.

In the vehicle 20 equipped with the vehicle management device of the embodiment, the first processing routine is executed when the vehicle side connector 51 and the external power supply side connector are connected while the vehicle is parked and external charging is permitted, and the second The processing routine is executed when the vehicle side connector 51 and the external power source side connector are connected while the vehicle is parked and external charging is permitted, and a predetermined time tref before the next scheduled traveling start time tst. However, the first and second processing routines are executed while parking at a first point (predetermined point) where parking is expected to be longer than a predetermined time, and when parking at a second point where parking is expected to be less than a predetermined time. There is no need to run it during the process. Here, the first point is a point where the parking time is expected to be relatively long (for example, 2 hours or more, 3 hours or more, 4 hours or more, etc.), such as a home, a hotel, or a storage location of the vehicle 20 when the vehicle 20 is used jointly by multiple users, such as in a parking lot or a rental car. The second location is a location where the parking time is expected to be relatively short (for example, less than 2 hours, less than 1.5 hours, less than 1 hour, etc.), such as an expressway service area or a shopping center This allows the first and second processing routines to be executed when the vehicle is parked in a location where the amount of electricity generated by the solar cells is small and will hardly contribute to charging the battery 36 before the next trip starts.

In the vehicle 20 equipped with the vehicle management device of the embodiment, the first processing routine is executed when the vehicle side connector 51 and the external power supply side connector are connected while the vehicle is parked and external charging is permitted, and the Qctag is set using the scheduled start time of the next run. However, while the vehicle is parked at the second location (e.g., charging station, etc.), the Qctag may be set using the scheduled start time of the next run at the first location (e.g., home, etc.). Note that this is useful when the second point and the first point are relatively close to each other.

Although the vehicle 20 equipped with the vehicle management device of the embodiment uses the battery 36 as the power storage device, a capacitor or the like may be used instead.

The correspondence between the main elements of the embodiment and the main elements of the disclosure described in SUMMARY will be described. In the embodiment, the motor 32 corresponds to a “drive unit,” the battery 36 corresponds to a “power storage device,” the solar cell system 40 corresponds to a “solar cell system,” and the electronic control unit 70 corresponds to a “vehicle management device.”

As for the correspondence between the main elements of the embodiment and the main elements of the disclosure described in SUMMARY, since the embodiment is an example for specifically describing a mode for carrying out the disclosure described in SUMMARY, the embodiment does not limit the elements of the disclosure described in SUMMARY. In other words, the interpretation of the disclosure described in SUMMARY should be performed based on the description in SUMMARY, and the embodiment is merely a specific example of the disclosure described in SUMMARY.

Although the modes for carrying out the disclosure have been described above with the embodiment, the disclosure is not limited to the embodiment, and may be embodied in various modes without departing from the scope of the disclosure.

This disclosure can be utilized for the manufacturing industry of a vehicle management device, etc.

What is claimed is:

1. A vehicle management device used for a vehicle that includes a drive unit for traveling, a power storage device that is able to supply power to the drive unit, and a solar cell system that is able to generate power from a solar cell and supply the power to the power storage device, and that is able to perform external charging in which the power storage device is charged with power from an outside of the vehicle, wherein when the vehicle is parked, a target external charging amount of the external charging is set to a value obtained by subtracting, from a target power storage amount of the power storage device at a next scheduled traveling start time, a predicted power generation amount of the solar cell up to the next scheduled traveling start time.

2. The vehicle management device according to claim 1, wherein when a power storage amount of the power storage device has not reached the target power storage amount by a predetermined time before the next scheduled traveling start time, the external charging is performed such that the power storage amount of the power storage device reaches the target power storage amount by the next scheduled traveling start time.

3. The vehicle management device according to claim 1, wherein when the vehicle is parked at a predetermined spot where the vehicle is assumed to be parked for a predetermined time or more, the target external charging amount is set to a value obtained by subtracting the predicted power generation amount from the target power storage amount.
